(19) United States
(12) Patent Application Publication
(10) Pub. No.: US 2011/0194796 A1
(43) Pub. Date: Aug. 11, 2011

(54) Angled Bore Bearing

(75) Inventors: Chris Hutchison, Gastonia, NC (US); Ron Brewer, Mooresville, NC (US)

(73) Assignee: SCHAEFFLER TECHNOLOGIES GMBH & CO. KG, Herzogenaurach (DE)

(21) Appl. No.: 13/020,501

(22) Filed: Feb. 3, 2011

Related U.S. Application Data
(60) Provisional application No. 61/301,861, filed on Feb. 5, 2010.

(51) Int. Cl. F16C 43/04

(52) U.S. Cl. 384/561

(57) ABSTRACT

The angled bore bearing converts rotary motion into linear motion and has an inner ring with a bore that is not perpendicular to the raceway grooves. Additionally, the angled bore bearing has rolling elements, an outer ring and optionally a cage. Optionally, an intermediate device can be used in place of the inner ring.

### FIELD OF INVENTION

The present invention relates generally to consumer power tools. More particularly, the present invention relates to the conversion of rotary motion into linear motion using an angled ball bearing.

### BACKGROUND OF THE INVENTION

Various devices, such a reciprocating saw, can convert rotary motion into linear motion. However, the shaft used in these devices must regularly be ground at an angle and many of these devices require a significant number of components. Thus, a device has been developed to convert rotary motion from a motor into linear motion, which can be used in various applications through a bearing that has an inner ring with a bore that is not perpendicular to the raceway.

Devices used to convert rotary motion into linear motion using an angled shaft are described, for example, in U.S. Pat. Nos. 5,725,058; 5,555,626; 7,127,973; 7,448,137; and U.S. Pat. Pub. No. 2001/0011420. However, manufacturing of an angled shaft is difficult and time consuming.

Additionally, yoke type devices used to convert rotary motion into linear motion are described, for example, in U.S. Pat. Nos. 5,079,844; 7,445,056; 5,392,519; and 5,212,887. However, these devices require a significant number of components.

Finally, devices which have connecting rods used to convert rotary motion into linear motion are described, for example, in U.S. Pat. Nos. 6,772,662; 6,732,815; and 5,561,909. However, similar to the yoke type devices, the devices using connecting rods require a significant number of components.

### SUMMARY OF THE INVENTION

The present invention provides an angled bore bearing for a device that converts rotary motion into linear motion.

Specifically, the invention pertains to a bearing that has a bore in an inner ring that is at a non-perpendicular angle from the raceway groove(s). The assembled bearing is fixed to the shaft through the inner ring by various methods. The angled bore produces a motion that results in a linear displacement as the shaft rotates. The linear displacement is created when the outer ring is kept from rotating, but allowed to move in a plane through the axis of the shaft. As the shaft rotates and the outer ring is kept from rotating, but allowed to move in a plane through the axis of the shaft, the raceway groove(s) moves from left to right with respect to a plane through the axis of the shaft. This in turn makes any given point on the outer ring result in a linear displacement.

Not required, but often necessary, the outer ring is attached to an extension piece, which provides a larger range of linear displacement. Additionally, in some cases, the outer ring and extension could be combined into one piece with the raceway groove(s) in the extension.

Varying either/both the angle of the bore relative to the raceway groove(s) and/or the length of the extension will result in an infinite number of linear distances the mechanism can achieve.

Broadly, the present invention can be defined as a bearing comprising an inner bearing ring which has an angled bore.

In one embodiment, the inner bearing ring has raceway grooves, and further comprises an outer bearing ring and an extension piece that has an upper body and a cylindrical lower body with a through bore. The outer bearing ring is arranged between the inner bearing ring and an inner face of the through bore of the cylindrical lower body of the extension piece. The outer bearing ring has raceway grooves and rolling elements arranged in the raceway grooves, whereby rotation of the inner bearing ring causes linear displacement of a distal end of the upper body.

In another embodiment, the bearing further comprises a cage arranged to support the rolling elements.

In another embodiment, the bearing further comprises a shaft is positioned in the angled bore of the inner bearing ring.

In yet another embodiment, the outer bearing ring is formed by the inner face of the through bore of the extension piece.

In a further embodiment, the upper body is tapered.

In one alternative embodiment, a bearing comprises an inner bearing ring which has an angled bore and raceway grooves and an extension piece which has a cylindrical lower body and an upper body. The lower body has a through bore defined by an inner surface, that forms an outer ring and the lower body has raceway grooves.

In a further embodiment of the alternative embodiment, the bearing further comprises rolling elements arranged in the raceway grooves and rotation of the inner bearing ring causes linear displacement of a distal end of the upper body.

In still a further embodiment of the alternate embodiment, the upper body is tapered.

In yet another alternative embodiment, a bearing assembly comprises a standard bearing which has a bore with a central axis and an intermediate device arranged in the bore of the bearing. The intermediate device has an outer surface parallel to the central axis and an inner bore at an angle to the central axis.

Preferably, in the other alternative embodiment, the bearing has an inner bearing ring, and further comprises an outer bearing ring and an extension piece that has an upper body and a cylindrical lower body with a through bore. The outer bearing ring is arranged between the inner bearing ring and an inner face of the through bore of the cylindrical lower body of the extension piece. The outer bearing ring has raceway grooves and rolling elements arranged in the raceway grooves, whereby rotation of the inner bearing ring causes linear displacement of a distal end of the upper body. Additionally, in the other alternate embodiment the upper body is tapered.

### BRIEF DESCRIPTION OF THE DRAWINGS

The present invention will be further understood and appreciated by reading the following description in conjunction with the accompanying drawings, in which:

FIG. 1 is a perspective view illustrating an angled bore bearing assembly within an extension with a shaft;

FIG. 2 is a perspective view illustrating an angled bore inner bearing ring;

FIG. 3 is a perspective view illustrating the extension piece in which the angled bore inner bearing ring, rolling elements and optionally a cage are fitted;

FIG. 4 is a cross-sectional view of the angled bore bearing assembly and the extension piece fitted together with a shaft installed;

FIG. 5 is a cross-sectional view of a bearing with an angled bore intermediate device;

FIG. 6 is a cross-sectional view illustrating the angled bore inner bearing ring and raceway grooves;

FIG. 7 is a cross-sectional view of the extension piece having raceway grooves;

FIG. 8 is a cross-sectional view illustrating the angled bore bearing assembly combined with the extension piece in an initial position; and

FIG. 9 is a cross-sectional view illustrating the angled bore bearing assembly combined with the piece in a final position after rotating the shaft.

### DETAILED DESCRIPTION OF THE INVENTION

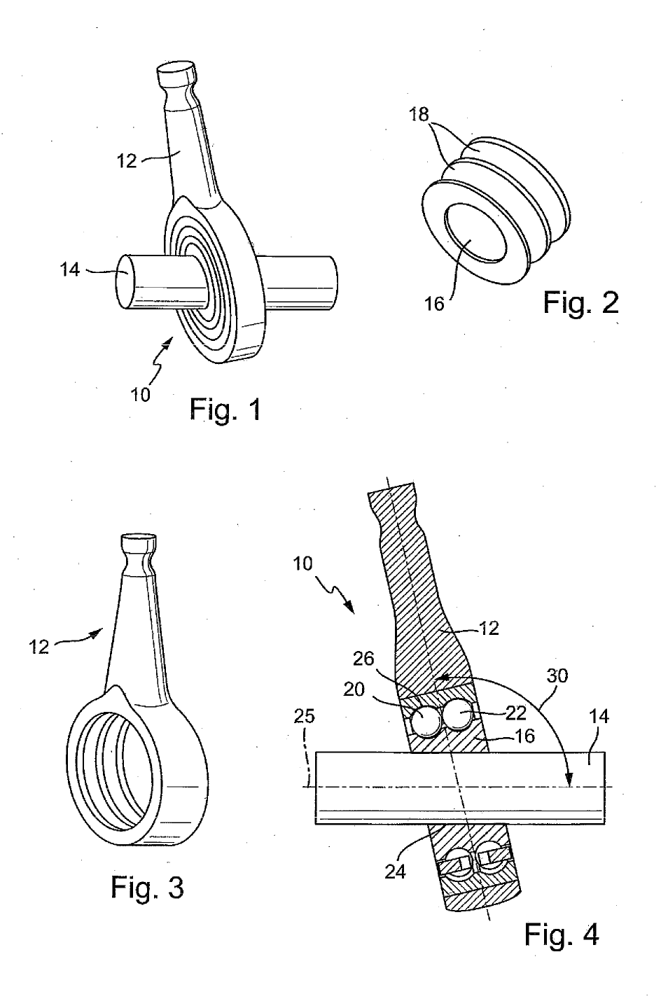

Referring now to the drawings, in which like reference numerals refer to like reference parts throughout, FIG. 1 shows a perspective view of the angled bore bearing assembly 10, an extension piece 12, and a shaft 14. The assembly 10 consists of an angled bore inner bearing ring 16 (shown in FIG. 2), rolling elements 20 (shown in FIG. 4), optionally a cage 22 (shown in FIG. 4) and an outer ring 26 (shown in FIG. 4).

FIG. 2 shows the angled bore inner bearing ring 16 and the raceway grooves 18.

FIG. 3 shows a perspective view of the extension piece 12 in which the angled bore inner bearing ring 16 (shown in FIG. 2), rolling elements 20 (shown in FIG. 4) and optionally a cage 22 (shown in FIG. 4) are fitted.

FIG. 4 shows a cross-sectional view of the assembled angled bore bearing assembly 10 (shown in FIG. 1) fixed in the extension piece 12 and to the shaft 14. The angled bore 24 (shown in FIG. 6) produces a motion that results in a linear displacement as the shaft 14 rotates. The linear displacement is created when the outer bearing ring 26 and the extension piece 12 are kept from rotating, but allowed to move in a plane through the axis 25 of the shaft 14, which forms a non-perpendicular angle 30 with the bearing raceways 18, 34. The raceway groove(s) 18, on which rolling elements 20 sit, move from left to right in an arc-like manner with respect to a plane through the axis 25 of the shaft 14, which in turn makes any given point on the outer bearing ring 26 result in a linear displacement. The rolling elements 20 could be secured by cages 22. The outer bearing ring 26 is attached to the extension piece 12 which provides a larger range of linear displacement.

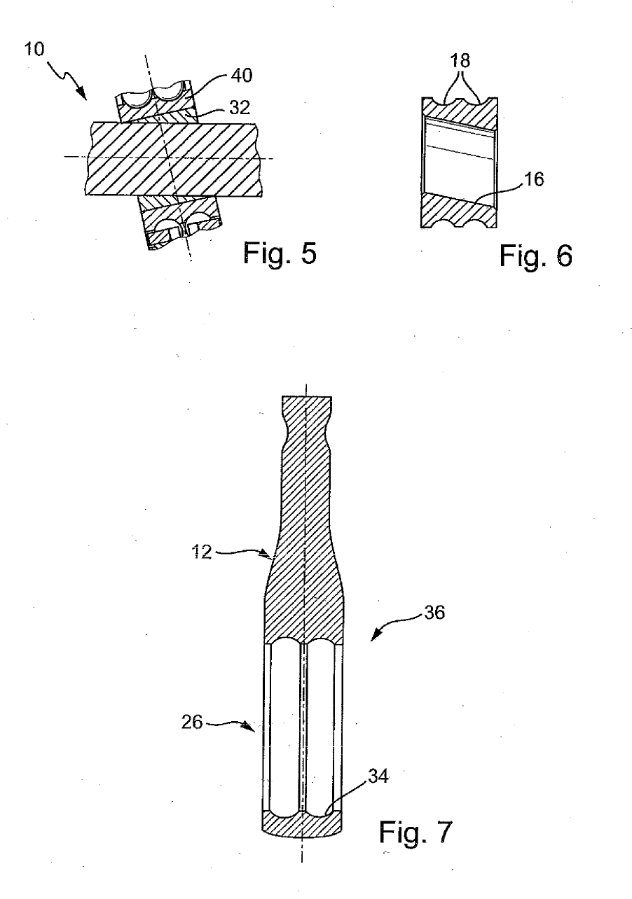

As a further embodiment of the angled bore bearing 10, FIG. 5 shows a cross-sectional view having an angled bore intermediate device 32 arranged in a standard bearing. When the intermediate device 32 is used in place of the angled bore inner bearing ring 16, a standard normal bearing 40 can be used. An angled bore on the inner bearing ring is not necessary.

FIG. 6 shows the angled slope of the angled bore inner bearing ring 16 and the raceway groove(s) 18.

Moreover, in some cases, shown in FIG. 7, the outer bearing ring 26 (shown in FIG. 4) and the extension piece 12 (shown in FIG. 4) can be combined into one piece with the raceway groove(s) 34 to form a single piece 36.

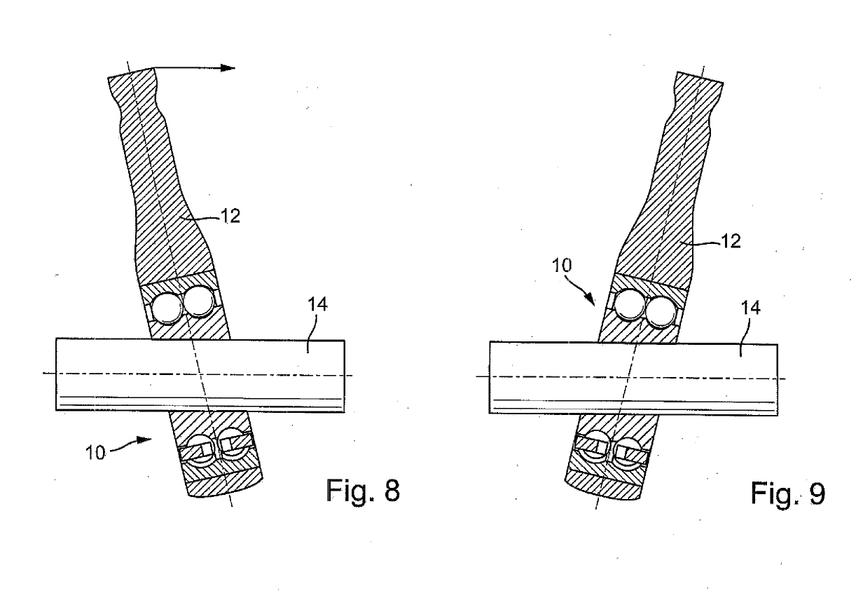

FIG. 8 shows the angled bore bearing ring 10 (shown in FIG. 1), extension 12 (shown in FIG. 4) and shaft 14 (shown in FIG. 4) in an initial position. Finally, FIG. 9 shows the angled bore bearing ring 10, extension 12 and shaft 14 in a final position after rotating 180°. The overall motion is linear. However, the movement can be characterized as an arc-like movement.

The present invention has been described with reference to a preferred embodiment. It should be understood that the scope of the present invention is defined by the claims and is not intended to be limited to the specific embodiment disclosed herein.

What is claimed is:

1. A bearing, comprising: an inner bearing ring having an angled bore.

2. The bearing of claim 1, wherein the inner bearing ring has raceway grooves, and further comprising an outer bearing ring and an extension piece having an upper body and a cylindrical lower body with a through bore, the outer bearing ring being arranged between the inner bearing ring and an inner face of the through bore of the cylindrical lower body of the extension piece, the outer bearing ring having raceway grooves, rolling elements being arranged in the raceway grooves, whereby rotation of the inner bearing ring causes linear displacement of a distal end of the upper body.

3. The bearing of claim 2, further comprising a cage arranged to support the rolling elements.

4. The bearing of claim 2, further comprising a shaft positioned in the angled bore of the inner bearing ring.

5. The bearing of claim 2, wherein the outer bearing ring is formed by the inner face of the through bore of the extension piece.

6. The bearing of claim 2, wherein the upper body is tapered.

7. A bearing, comprising:
an inner bearing ring having an angled bore and raceway grooves; and
an extension piece having a cylindrical lower body and an upper body, the lower body having a through bore defined by an inner surface, the inner surface forming an outer ring and having raceway grooves.

8. The bearing of claim 7, further comprising rolling elements arranged in the raceway grooves and rotation of the inner bearing ring causes linear displacement of a distal end of the upper body.

9. The bearing of claim 7, wherein the upper body is tapered.

10. A bearing assembly, comprising:
a standard bearing having a bore with a central axis; and
an intermediate device arranged in the bore of the bearing, the intermediate device having an outer surface parallel to the central axis and an inner bore at an angle to the central axis.

11. The bearing assembly of claim 10, wherein the bearing has an inner bearing ring, and further comprising an outer bearing ring and an extension piece having an upper body and a cylindrical lower body with a through bore, the outer bearing ring being arranged between the inner bearing ring and an inner face of the through bore of the cylindrical lower body of the extension piece, the outer bearing ring having raceway grooves, rolling elements being arranged in the raceway grooves, whereby rotation of the inner bearing ring causes linear displacement of a distal end of the upper body.

12. The bearing assembly of claim 11, wherein the upper body is tapered.
